(19) United States
(12) Patent Application Publication
(10) Pub. No.: US 2012/0299882 A1
(43) Pub. Date: Nov. 29, 2012

(54) PROGRAMMABLE BUTTONS FOR EREADER DEVICE

(76) Inventor: Michelle A. Warvel, San Francisco, CA (US)

(21) Appl. No.: 13/478,843

(22) Filed: May 23, 2012

Related U.S. Application Data
(60) Provisional application No. 61/489,202, filed on May 23, 2011.

(51) Int. Cl. G06F 3/033; G06F 3/048

(52) U.S. Cl. 345/184; 715/765

(57) ABSTRACT

A system and method operable on an electronic device that has mechanical buttons for navigation functions. The mechanical buttons have default configurations for their associated navigation functions, e.g., page forward, page back. The system and method allow the user to change navigation functions associated with the mechanical buttons to suit her use of the device. Specifically, the system and method has a Setting screen, that allows the user to chose the navigational directions associated with the mechanical buttons. These user selections are stored in the device and are used to configure the operation of the mechanical buttons for the present an subsequent uses of the device.

### CROSS-REFERENCE TO RELATED APPLICATION

This application claims benefit of U.S. Provisional Application No. 61/489,202, filed May 23, 2011, which is hereby incorporated by reference.

### FIELD OF THE INVENTION

The present invention generally relates to systems and methods for turning pages of digital publications in an electronic device, and more particularly to systems and methods for controlling the direction of page turns associated with mechanical buttons in a portable electronic reading device.

### BACKGROUND OF THE INVENTION

Electronic content readers typically have mechanical buttons, switches, for controlling the display of electronic publications, e.g., electronic books or magazines. Typically. there are two to four buttons on each side of the device, placed on the top side of the device where the user's fingers of her hands holding the device would rest. In conventional devices, these buttons are hard coded in software to turn pages of the content in only one direction.

### SUMMARY OF THE INVENTION

The system and method of the present invention operate on electronic devices that have mechanical buttons. In the preferred embodiment, the electronic device is a mobile device such an electronic book reader or a tablet device and the mechanical buttons are used for navigating in digital publications displayed on the device.

The mechanical buttons have default configurations for their associated navigation functions, e.g., page forward, page back. The system and method of the present invention allows the user to change navigation functions associated with the mechanical buttons to suit her use of the device. Specifically, the system and method has a Setting screen, that allows the user to chose the navigational directions associated with the mechanical buttons. These user selections are stored in the device and are used to configure the operation of the mechanical buttons for the present use and for the subsequent uses of the device.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 depicts an exemplary electronic reader with mechanical switches for facilitating page turns;

FIG. 2 illustrates a preferred implementation of a user interface for the programmable mechanical buttons of the present invention; and

FIG. 3 depicts the components of an exemplary device.

### DETAILED DESCRIPTION OF THE INVENTION

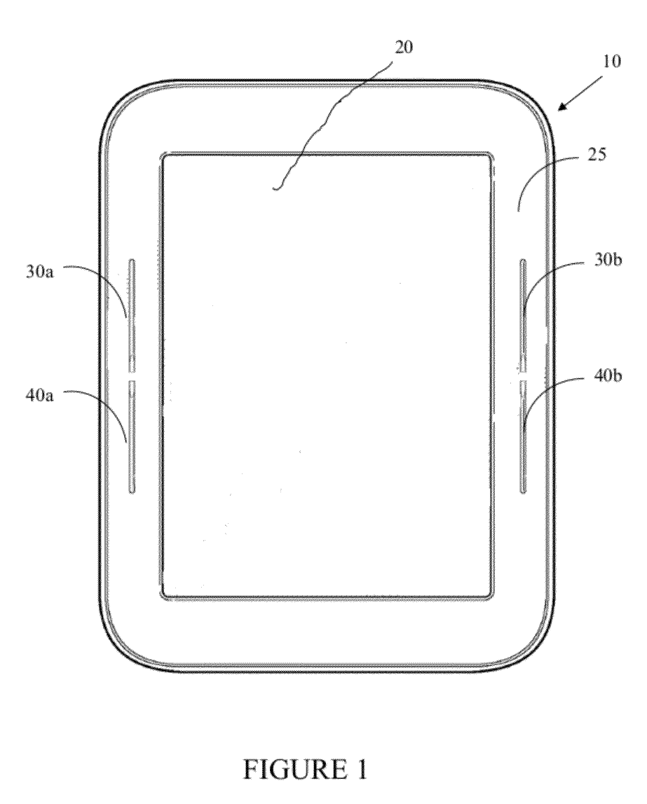

FIG. 1 illustrates an electronic reading device 10 that can be used to implement the present invention. In the preferred embodiment, device 10 is portable electronic device that the user may hold in his or her hand, such as a digital media player, a personal e-mail device, a personal data assistant (“PDA”), a cellular telephone, a handheld gaming device, a tablet device or an eBook reader.

The device 10 includes a case or frame 25 and a screen 20. The electronic publications being viewed are displayed on screen 20, which can be, for example, and Liquid Crystal Display (LCD) screen or an Electronic Paper Device (EPD) screen. The orientation of device 10 illustrated in FIG. 1 is the orientation in which a user would typically hold the device 10 when reading an electronic publication on the device 10.

Arrayed on the frame 25 of device 10 are four mechanical buttons, switches, 30a, 30b, 40a, 40b. These switches 30a, 30b, 40a, 40b are located on the frame 25 in positions where the user's fingers (or thumbs) would naturally be positioned when holding the device 10. In the default configuration of device 10, switches 40a and 40b, when activated by the user, cause a forward page turn of the electronic publication being displayed on the screen 20. In the preferred embodiment, switches 40a and 40b perform the same function, but are located on opposite sides of the frame 25 in order to accommodate left and right handed users. In a complimentary fashion, switches 30a and 30b, in the preferred default configuration, cause a backward page turn of the electronic publication when activated.

Although the preferred embodiment of the present invention, which includes four switches 30a, 30b, 40a, 40b is illustrated in FIG. 1, as appreciated by those skilled in the art, the present invention of programmable switches is equally applicable to a two switch configuration. For example, a single left hand switch in its default configuration can perform a backward page turn, while a single right hand switch in its default configuration can perform a forward page turn. The direction of the page turn initiated by the activation of the respective switches can be changed by the user as described below.

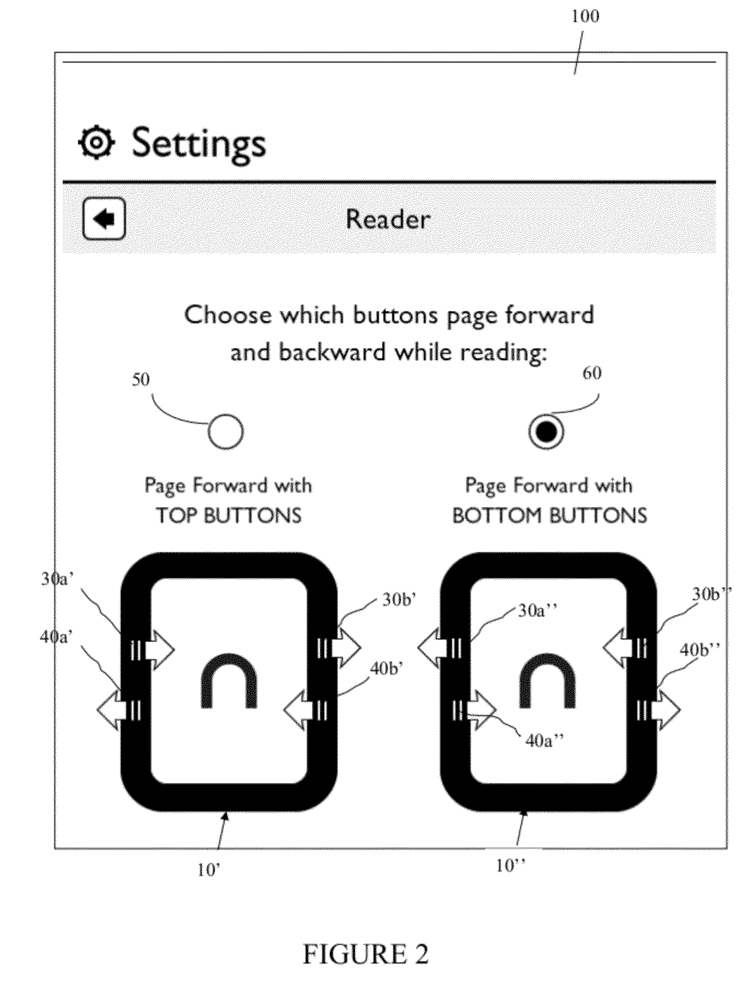

Referring to FIG. 2, the electronic device 10 of the present invention includes a Settings User Interface (UI) 100 that allows the user to change the direction of the page turn enabled in response to the activation of the mechanical switches 30a, 30b, 40a and 40b found on the frame 25 of the device 10.

The Setting screen 100 includes two virtual representations 10′ and 10″ of the physical device 10. Similarly, the virtual devices 10′ and 10″ have virtual switches 30a′, 30b′, 40a′, 40b′ and 30a″, 30b″, 40a″, 40b″ illustrated thereon.

The two virtual representations 10′ and 10″ of the physical device 10 in Setting screen 100 represent the two preferred programmable states of the buttons 30a, 30b, 40a and 40b. In the virtual representation 10″, in the default configuration, the left side upper button 30a″ turns the page backward in the digital content being displayed on screen 20 and the lower button 40a″ turns the page forward. Complimentarily, the upper right hand button 30b″ turns the page backward while switch 40b″ turns the page forward.

The Settings screen 100 allows the user to change the page turning direction associated with the mechanical switches 30a-40b. If the user clicks on the radio button 60 on Settings screen 100, the page turning direction of the buttons 30a-40b are as described above in the default configuration as illustrated in association with the virtual representation 10″. In order to change the page turning direction of the switches, the user can click on radio button 50. Once the user has changed the navigation configuration of the switches 30a-40b through UI screen 100, the user's selected configuration is stored in a memory of device 10 as further described below.

As depicted in the illustration of device 10′ in FIG. 2, when the user clicks on the radio button 50, the upper buttons 30a′ and 30b′ will cause a forward navigation in the electronic content (preferably turn one page forward) and the lower buttons 40a′ and 40b′ will cause a backward navigation through the content.

In the preferred embodiment the two upper switches 30a and 30b on the device 10 cause a page turn in the same direction and the two lower switches 40a and 40b cause a page turn in the opposite direction. As appreciated by those skilled in the art, the present invention can be employed to provide any configuration of page turns. For example, the right hand buttons 30b and 40b can both be programmed to cause page turns in the same direction and the left hand buttons 30a and 40a can cause page turns in the opposite direction.

Although in the preferred embodiment, the activation of a switch 30a-40b causes a page turn in an electronic document, as appreciated by those skilled in the art, the navigation function of the switches 30a-40b can be for any unit of navigation, for example, a chapter in an eBook, an article in an electronic magazine, a story in an digital newspaper or a screen on a web page. Further, the navigation configuration selected by the user can be application specific. For example, the user can select one navigation configuration of the switches 30a-40b for their eBook reader application and have a different navigation configuration for the switches 30a-40b for a different application, such as a pdf reader.

As appreciated by those skilled in the art, the device 10 can be provided with only two buttons, one on either side, and the present invention can be employed to change the navigation of these two buttons in opposite directions, as desired by the user. Similarly, the two buttons can be provided on a single side, and the present invention can change the navigation direction associated with the activation of the button.

Although in the preferred embodiment, the buttons on the device are implemented as mechanical devices, it is appreciated by those skilled in the art that the programmable navigation changes of the present invention are equally applicable to virtual keys displayed on a screen of the device.

The following is exemplary source code for implementing a preferred embodiment of the programmability of the switches in the Settings UI as described above:

```
  public void storePageForwardMapping(int value) {
    SharedPreferences sharedPreferences =
this.getSharedPreferences(“ReaderPreferences”,
Context.MODE_PRIVATE);
sharedPreferences.edit( ).putInt(ReaderCommonUIConstants.-
USER_PREFERENCE_PAG E_FORWARD_MAPPING,
value).commit( );
  }
  public int loadPageForwardMapping( ) {
    SharedPreferences sharedPreferences =
this.getSharedPreferences(“ReaderPreferences”,
Context.MODE_PRIVATE);
    return
sharedPreferences.getInt(ReaderCommonUIConstants.-
USER_PREFERENCE_{—}
PAGE_FORWARD_MAPPING,
ReaderCommonUIConstants.-
PAGE_FORWARD_MAPPING_VALUE_0);
  }
  public void onClick(View v) {
    if (v == group0) {
      rb0.setChecked(true);
      rb1.setChecked(false);
this.storePageForwardMapping(ReaderCommonUIConstants.-
PAGE_FORWARD_MAPPING_VALUE_0);
    } else if (v == group1) {
      rb0.setChecked(false);
      rb1.setChecked(true);
this.storePageForwardMapping(ReaderCommonUIConstants.-
PAGE_FORWARD_MAPPING_VALUE_1);
    }
  }
  private void populateRadioButtonState ( ) {
    int pageForwardMapping = this.loadPageForwardMapping( );
    if (pageForwardMapping ==
ReaderCommonUIConstants.-
PAGE_FORWARD_MAPPING_VALUE_0 ) {
      rb0.setChecked( true );
      rb1.setChecked( false );
    }
    else {
      rb0.setChecked( false );
      rb1.setChecked( true );
    }
  }
```

The following is exemplary interpretation source code that allows the device 10 to respond appropriately, e.g., in a Reader application, when the user presses a page turn button/switch. The system interprets the key code based on what the user has chosen in Settings as described above. Essentially, the system turn a low-level signal, e.g., a platform keycode, into a higher-level turn-the-page-forward or turn-the-page-backward command. The interpretative source code is follows:

```
  boolean bNextPage;
  if (((keyCode == KeyEvent.KEYCODE_PAGE_TOPLEFT ||
keyCode == KeyEvent.KEYCODE_PAGE_TOPRIGHT) &&
(this.mPageTurnBtnPref ==
ReaderCommonUIConstants.-
  PAGE_FORWARD_MAPPING_VALUE_0))
  || ((keyCode == KeyEvent.KEYCODE_PAGE_BOTTOMLEFT
|| keyCode ==
KeyEvent.KEYCODE_PAGE_BOTTOMRIGHT) &&
(this.mPageTurnBtnPref ==
ReaderCommonUIConstants.-
PAGE_FORWARD_MAPPING_VALUE_1))) {
    bNextPage = true;
}
else {
    bNextPage = false;
}
```

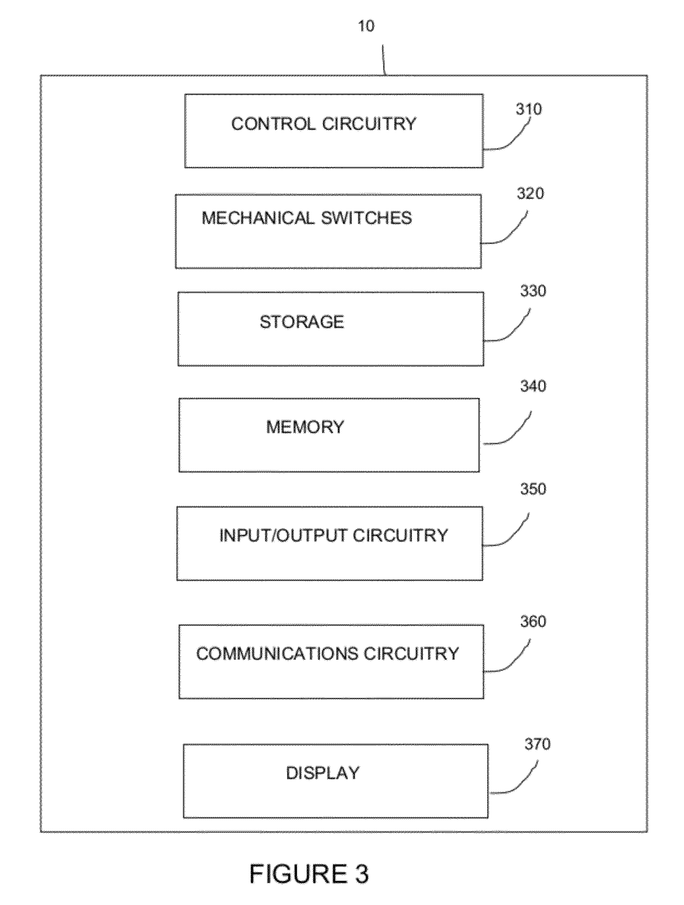

FIG. 3 illustrates an exemplary device 10 employing the present invention. As appreciated by those skilled the art, the device 10 can take many forms capable of operating the present invention. In a preferred embodiment, the device 10 is a mobile electronic device, and in an even more preferred embodiment device 10 is an electronic reader device, such as a tablet device. Electronic device 10 can include control circuitry 310, storage 330, memory 340, input/output (“I/O”) circuitry 350, communications circuitry 360, and display 370. In some embodiments, one or more of the components of electronic device 10 can be combined or omitted, e.g., storage 330 and memory 340 may be combined. As appreciated by those skilled in the art, electronic device 10 can include other components not combined or included in those shown in FIG. 3, e.g., a power supply such as a battery, an input mechanism, etc.

Electronic device 10 can include any suitable type of electronic device. For example, electronic device 10 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 10 can include a larger portable electronic device, such as a laptop computer.

Control circuitry 310 can include any processing circuitry or processor operative to control the operations and performance of electronic device 10. For example, control circuitry 310 can be used to run operating system applications, firmware applications, media playback applications, media editing applications, or any other application. Control circuitry 310 can drive the display 370 and process inputs received from a user interface, e.g., a touch screen display 370.

Mechanical Switches 320 include the buttons or switches 30a-40b described above, as well as the circuitry required to interface the switches 320 to the other components of the device 10. As the user presses, activates the mechanical switches 320, the activated switch sends a signal, preferable through the I/O circuitry 350 described below, to the Control Circuitry 310. Alternatively, the conversion of the mechanical activation of the switches 320 can be performed directly by the I/O Circuitry 350. As previously described, the page turn response of the device 10 has a default configuration, or has been re-programmed by the user.

Storage 330 can include, for example, one or more storage mediums including a hard-drive, solid state drive, flash memory, permanent memory such as ROM, any other suitable type of storage component, or any combination thereof. Storage 330 can store, for example, media content, e.g., eBooks, music and video files, application data, e.g., software for implementing functions on electronic device 10, firmware, user preference information data, e.g., content preferences, authentication information, e.g., libraries of data associated with authorized users, transaction information data, e.g., information such as credit card information, wireless connection information data, e.g., information that can enable electronic device 10 to establish a wireless connection, subscription information data, e.g., information that keeps track of podcasts or television shows or other media a user subscribes to, contact information data, e.g., telephone numbers and email addresses, calendar information data, and any other suitable data or any combination thereof. As described above, the storage 330 can be used to store the user selected configuration for the navigation function of the mechanical switches 320. This configuration can be retrieved from the storage 330 as the device is in use.

Memory 340 can include cache memory, semi-permanent memory such as RAM, and/or one or more different types of memory used for temporarily storing data. In some embodiments, memory 340 can also be used for storing data used to operate electronic device applications, or any other type of data that can be stored in storage 330. In some embodiments, memory 340 and storage 330 can be combined as a single storage medium.

I/O circuitry 350 can be operative to convert, and encode/decode, if necessary analog signals and other signals into digital data. In some embodiments, I/O circuitry 350 can also convert digital data into any other type of signal, and vice-versa. For example, I/O circuitry 350 can receive and convert physical contact inputs, e.g., from a multi-touch screen, i.e., display 370, physical movements, e.g., from a mouse or sensor, analog audio signals, e.g., from a microphone, or any other input. In the preferred embodiment, I/O circuitry 350 converts the physical activation of mechanical switches 320 in to electrical signals that are used by the Control Circuitry to perform a page turn. The digital data can be provided to and received from control circuitry 310, storage 330, and memory 340, or any other component of electronic device 10. Although I/O circuitry 350 is illustrated in FIG. 3 as a single component of electronic device 10, several instances of I/O circuitry 350 can be included in electronic device 10.

Electronic device 10 can include any suitable interface or component for allowing a user to provide inputs to I/O circuitry 350. For example, electronic device 10 can include any suitable input mechanism, such as a button, keypad, dial, a click wheel, or a touch screen, e.g., display 370, and in the preferred embodiment, mechanical switches 320. In some embodiments, electronic device 10 can include a capacitive sensing mechanism or a multi-touch capacitive sensing mechanism.

In some embodiments, electronic device 10 can include specialized output circuitry associated with output devices such as, for example, one or more audio outputs. The audio output can include one or more speakers, e.g., mono or stereo speakers, built into electronic device 10, or an audio component that is remotely coupled to electronic device 10, e.g., a headset, headphones or earbuds that can be coupled to device 10 with a wire or wirelessly.

Display 370 includes the display and display circuitry for providing a display visible to the user. For example, the display circuitry can include a screen, e.g., an LCD screen, that is incorporated in electronics device 10. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 10, information regarding ongoing communications operations, information regarding incoming communications requests, or device operation screens, under the direction of control circuitry 310. Alternatively, the display circuitry can be operative to provide instructions to a remote display.

Communications circuitry 360 can include any suitable communications circuitry operative to connect to a communications network and to transmit communications, e.g., data from electronic device 10 to other devices within the communications network. Communications circuitry 360 can be operative to interface with the communications network using any suitable communications protocol such as, for example, Wi-Fi, e.g., a 802.11 protocol, Bluetooth, radio frequency systems, e.g., 10 MHz, 1.4 GHz, and 5.6 GHz communication systems, infrared, GSM, GSM plus EDGE, CDMA, quadband, and other cellular protocols, VOIP, or any other suitable protocol.

Electronic device 10 can include one more instances of communications circuitry 360 for simultaneously performing several communications operations using different communications networks, although only one is shown in FIG. 3 to avoid overcomplicating the drawing. For example, electronic device 10 can include a first instance of communications circuitry 360 for communicating over a cellular network, and a second instance of communications circuitry 360 for communicating over Wi-Fi or using Bluetooth. In some embodiments, the same instance of communications circuitry 360 can be operative to provide for communications over several communications networks.

In some embodiments, electronic device 10 can be coupled to a host device for data transfers, synching the communications device, software or firmware updates, providing performance information to a remote source, e.g., providing reading characteristics to a remote server, or performing any other suitable operation that can require electronic device 10 to be coupled to a host device. Several electronic devices 10 can be coupled to a single host device using the host device as a server. Alternatively or additionally, electronic device 10 can be coupled to several host devices, e.g., for each of the plurality of the host devices to serve as a backup for data stored in electronic device 10.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for configuring a navigation function of mechanical switches of an electronic device comprising:
associating respective first navigation functions with each of the mechanical switches;
providing an interface to allow a user to change the navigation functions associated with the mechanical switches;
receiving input from the user specifying respective second navigation functions to be associated with each of the mechanical switches;
associating the respective second navigation functions with each of the mechanical switches; and
storing the associated respective second navigation functions.

2. The method of claim 1, wherein the act of associating respective second navigation functions with each of the mechanical switches further comprises associating a respective navigation direction with each of the mechanical switches.

3. The method of claim 2, wherein the respective navigation directions are navigation directions in a digital publication.

4. The method of claim 2, wherein the act of associating respective second navigation functions with each of the mechanical switches further comprises associating a page forward or a page backward function with each of the mechanical switches.

5. The method of claim 1, wherein the act of associating respective second navigation functions with each of the mechanical switches further comprises associating respective second navigation functions to four mechanical switches.

6. The method of claim 1, wherein the act of associating respective second navigation functions with each of the mechanical switches further comprises associating respective second navigation functions to two mechanical switches.

7. A system for an electronic device comprising:
a housing;
a display disposed in the housing;
a plurality of mechanical switches disposed on the housing;
input/output circuitry;
a memory; and
control circuitry that controls operation of the system, the control circuitry operatively coupled to the mechanical switches, the display, the memory and to the input/output circuitry,
wherein the control circuitry is operable to:
associate respective first navigation functions with each of the mechanical switches in accordance with settings stored in the memory;
provide an interface on the display to allow a user to change the navigation functions associated with the mechanical switches;
receive signals from the input/output circuitry, the signals representing input from the user specifying respective second navigation functions to be associated with each of the mechanical switches;
associate the respective second navigation functions with each of the mechanical switches; and
store the associated respective second navigation functions in the memory.

8. The system of claim 7, wherein the second navigation functions comprise navigation directions.

9. The system of claim 8, wherein the respective navigation directions are navigation directions in a digital publication.

10. The system of claim 8, wherein the respective second navigation comprise a page forward and a page backward function.

11. The system of claim 7, wherein the plurality of mechanical switches consists of four mechanical switches.

12. The system of claim 7, wherein the plurality of mechanical switches consists of two mechanical switches.

13. The system of claim 7, wherein the electronic device is a portable electronic device.

14. The system of claim 7, wherein the electronic device is an electronic book reader.
